(19) United States
(12) Patent Application Publication
(10) Pub. No.: US 2009/0316400 A1
(43) Pub. Date: Dec. 24, 2009

(54) LIGHT EMITTING DIODE STREET LIGHT

(75) Inventors: Yuan-Lung Kuo, Tu-Cheng (TW); Han-Lung Lee, Tu-Cheng (TW); Da-Wei Lin, Tu-Cheng (TW); Sei-Ping Louh, Tu-Cheng (TW); Shih-Che Chien, Tu-Cheng (TW); Tai-Cherng Yu, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/430,778

(22) Filed: Apr. 27, 2009

(30) Foreign Application Priority Data
Jun. 24, 2008 (CN) 200810302288.2

(51) Int. Cl. F21V 21/00; F21V 29/00

(52) U.S. Cl. 362/235; 362/249.02; 362/294

(57) ABSTRACT

An exemplary light emitting diode (LED) streetlight includes an LED light source and a heat dissipating module. The LED light source includes a circuit board and a plurality of LEDs. The circuit board has a first surface and a second surface. The LEDs are disposed on the first surface and electrically connected to the circuit board. The heat dissipating module includes a heat conducting plate, a plurality of heat pipes containing a working liquid and a plurality of fins. The heat conducting plate has a bonding surface and a heat dissipating surface opposite to the bonding surface. Each heat pipe has a heated section thermally connected to the heat dissipating surface and a condensing section spaced from the heat dissipating plate and penetrate into the plurality of fins. The circuit board is fixed on the bonding surface of the heat conducting plate.

### BACKGROUND

1. Technical Field

The present invention generally relates to streetlights, particularly, to a streetlight employing a light emitting diode as light source.

2. Discussion of Related Art

Light emitting diodes (LED) have been used extensively as light sources for streetlights due to their high luminous efficiency and low power consumption.

Radiant efficiency and lifespan of the LEDs may be distinctly reduced by high working temperature, thereby easily leading to low reliability. As such, a typical LED streetlight usually includes a circuit board, a metal frame and a heat dissipating module. The LEDs are disposed on the circuit board. The metal frame is for fixing the LEDs and the circuit board. The heat dissipating module is for dissipating heat generated by the LEDs. However, using metal frames leads to complex configurations and heavy weights of the LED streetlight, thereby causing inconvenience when the LED streetlight needs to be disassembled or repaired.

Therefore, there is room for improvement within the art.

### BRIEF DESCRIPTION OF THE DRAWINGS

Many aspects of the present LED streetlight can be better understood with reference to the following drawings. The components in the drawings are not necessarily drawn to scale, the emphasis instead being placed upon clearly illustrating the principles of the present LED streetlight. Moreover, in the drawings, like reference numerals designate corresponding parts throughout the several views, wherein:

FIG. 1 is a schematic view of an LED streetlight, according to a first exemplary embodiment;

FIG. 2 is an exploded view of the LED streetlight illustrated in FIG. 1.

FIG. 3 is a schematic view of a circuit board which has a plurality of LEDs with staggered pattern disposed thereon.

FIG. 4 is a schematic view of a circuit board equipped with light reflecting film or light reflecting plate.

### DETAILED DESCRIPTION OF THE PREFERRED EMBODIMENTS

Reference will now be made to the drawings to describe the embodiments of the present LED streetlight, in detail.

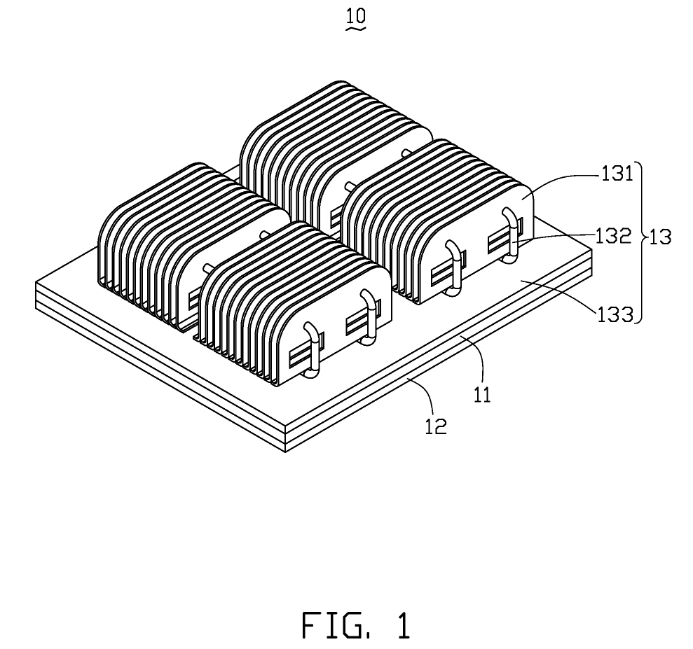

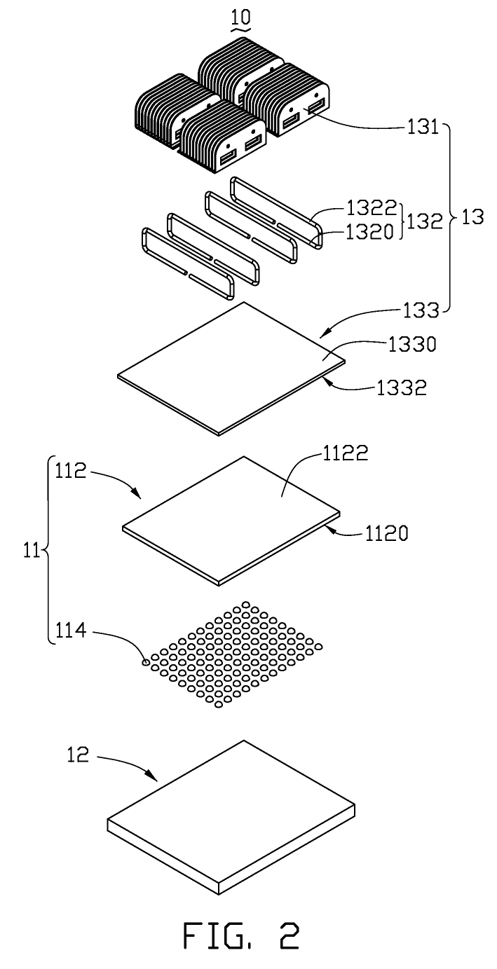

Referring to FIG. 1 and FIG. 2, a light emitting diode (LED) streetlight 10, according to a first exemplary embodiment is provided. The LED streetlight 10 includes an LED light source 11, a light diffusing board 12 and a heat dissipating module 13.

The LED light source 11 includes a circuit board 112 and a plurality of LEDs 114. The circuit board 112 includes a first surface 1120 and an opposite second surface 1122. The circuit board 112 is configured for providing electrical power to the plurality of LEDs 114. The plurality of LEDs 114 are disposed on the first surface 1120 and electrically connected to the circuit board 112. The circuit board 112 can be a metal core printed circuit board (MCPCB).

The light diffusing board 12 is disposed at one side of the first surface 1120 and faces to the LEDs 114 disposed on the first surface 1120. The light diffusing board 12 is configured for diffusing light emitted from the plurality of LEDs 114. The light diffusing board 12 can be a resin layer having a plurality of micro particles distributed therein. Thereby, light emitted from the plurality of LEDs 114 can be diffused when passing through the light diffusing board 12. Of course, the light diffusing board 12 can also be a transparent plate having micro structures formed thereon, or a glass plate having a plurality of micro particles distributed therein.

The heat dissipating module 13 includes a plurality of fins 131, a plurality of heat pipes 132 containing a working liquid (not shown) and a heat conducting plate 133. The heat conducting plate 133 is made of metals having high heat conductivity, such as aluminum. The heat conducting plate 133 includes a heat dissipating surface 1330 and a bonding surface 1332 opposite to the heat dissipating surface 1330. The circuit board 112 is fixed on the bonding surface 1332. The bonding surface 1332 is opposite and thermally connected to the second surface 1122 of the circuit board 112. Each heat pipe 132 has a heated section 1320 and a condensing section 1322. The heat dissipating surface 1330 is thermally connected to the heated sections 1320 of the heat pipes 132 and transfers heat from the LEDS to the working liquid, thereby vaporizing the working liquid. The condensing sections 1322 of the plurality of the heat pipes 132 are spaced from the heat conducting plate 133 and penetrate into the fins 131; thereby the condensing sections 1322 are thermally connected to the fins 131. As the fins 131 absorb the heat from the vaporized working fluid, the vaporized working fluid condenses back into liquid form. Each heat pipe 132 is spaced from, and parallel to, each other.

During functioning of the LED streetlight 10, heat generated by the LEDs 114 is transferred to the heat conducting plate 133 by the circuit board 112, thereby decreasing working temperature of the LEDs 114. Heat transferred to the heat conducting plate 133 is transferred to the working liquid in the heat pipes 132, to the fins 131 and dissipated to the exterior environment through vaporization and condensation of the working liquid.

The second surface 1122 of the circuit board 112 can also be thermally connected to the bonding surface 1332 of the heat conducting plate 133 by thermal paste, thereby, high heat conductivity is achieved.

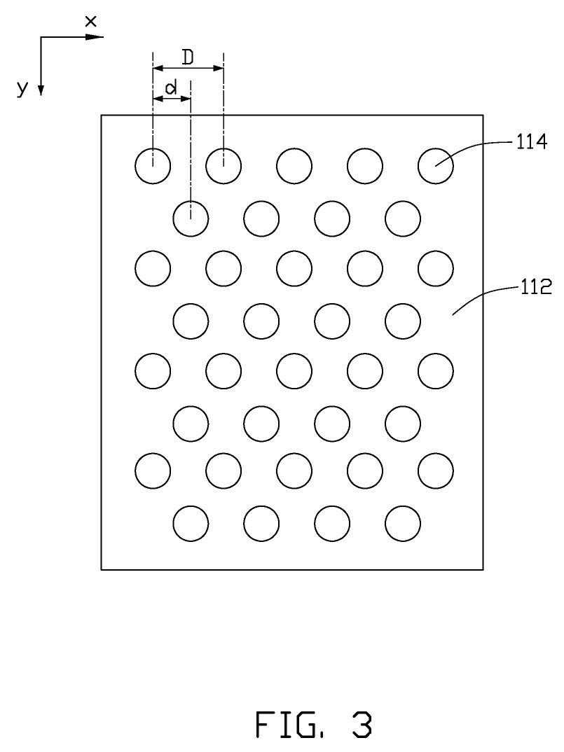

The plurality of LEDs 114 can also be disposed on the first surface 1120 of the circuit board 112 with staggered pattern, thereby improving uniformity of lights emitted from the LEDs 114. Referring to FIG. 3, the LEDs 114 are arranged into several rows. Each row of LEDs 114 extends along a direction “x”, and every two neighboring LEDs of the same row have an interval “D” defined therebetween. The LEDs 114 of a random first row projects along a direction “y”, fall on an arrangement line of a neighbor second row. The projections of the first row and the LEDs 114 of the second row are alternately distributed. There is an interval “d” defined between each projection and a neighboring LEDs 114.

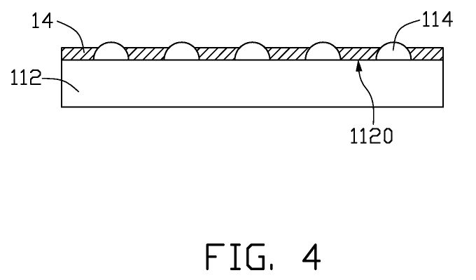

Referring to FIG. 4, a light reflecting film 14 is disposed on the first surface 1120 of the circuit board 112, thereby reflecting lights emitted by the LEDs 114 and improving light utilization efficiency thereof. The light reflecting film 14 covers a remained portion of the first surface 1120, which is uncovered by the LEDs 114. In addition, the light reflecting film 14 can also be replaced by a light reflecting plate.

Due to that the circuit board 112 of the LED street light 10 is fixed on the heat conducting plate 133 and forms a thermal contact therebetween, additional component (such as metal frame) is unnecessary for fixing the LED light source 11. As such, the LED street light 10 has simpler configuration than typical LED streetlights.

Finally, it is to be understood that the above-described embodiments are intended to illustrate rather than limit the invention. Variations may be made to the embodiments without departing from the spirit of the invention as claimed. The above-described embodiment illustrates the scope of the invention but do not restrict the scope of the invention.

What is claimed is:

1. A light emitting diode (LED) streetlight, comprising:
an LED light source comprising a circuit board and a plurality of LEDs, the circuit board having a first surface and an opposite second surface, the LEDs being disposed on the first surface and electrically connected to the circuit board; and
a heat dissipating module comprising a heat conducting plate, a plurality of heat pipes containing a working liquid and a plurality of fins, the heat conducting plate having a bonding surface and a heat dissipating surface opposite to the bonding surface, each heat pipe having a heated section at which the working liquid is vaporized and a condensing section at which the vaporized working liquid condenses, the heated sections of each heat pipe being thermally connected to the heat dissipating surface, the condensing sections of each heat pipe being spaced from the heat dissipating plate and penetrating into the plurality of fins, wherein the circuit board is fixed on the bonding surface of the heat conducting plate.

2. The LED streetlight according to claim 1, further comprising a light diffusing board disposed at the side of the first surface of the circuit board and facing to the LEDs disposed on the first surface.

3. The LED streetlight according to claim 1, wherein the circuit board is metal core print circuit board.

4. The LED streetlight according to claim 1, wherein the plurality of LEDs are disposed on the first surface of the circuit board with staggered pattern.

5. The LED streetlight according to claim 1, further comprising a light reflecting film formed on the first surface of the circuit board, the light reflecting film covering a remained portion of the first surface which is uncovered by the LEDs.

6. The LED streetlight according to claim 1, wherein the heat conducting plate is made of aluminum.

7. The LED streetlight according to claim 1, wherein the second surface of the circuit board is thermally connected to the bonding surface of the heat conducting plate by thermal paste.
